(19) United States
(12) Patent Application Publication
(10) Pub. No.: US 2012/0072534 A1
(43) Pub. Date: Mar. 22, 2012

(54) Method and System for the Exposure of Simplified Data-Service Facades Through a Context Aware Access Layer

(75) Inventors: Brian McColgan, Toronto (CA); Gaelle Christine Martin-Cocher, Toronto (CA)

(73) Assignee: Research In Motion Limited, Waterloo, ON (CA)

(21) Appl. No.: 13/263,458

(22) PCT Filed: Apr. 7, 2010
(86) PCT No.: PCT/CA2010/000481

§ 371 Date: Nov. 16, 2011

Related U.S. Application Data
(60) Provisional application No. 61/168,453, filed on Apr. 10, 2009.

(51) Int. Cl. G06F 15/16

(52) U.S. Cl. 709/217

(57) ABSTRACT

An intermediary mechanism is provided. The intermediary mechanism is configured to receive a request from a client device, request the data from a data store, receive a response containing response data from the data store, process the response data using context information that relates to the client device to determine contextually relevant information, and transmit the contextually relevant information to the client device.

### CROSS-REFERENCE TO RELATED APPLICATIONS

This application is a filing under 35 U.S.C. 371 of International Application No. PCT/CA2010/000481 filed Apr. 7, 2010, entitled “Method and System for the Exposure of Simplified Data-Service Facades Through a Context Aware Access-Layer” (Atty. Docket No. 34902-WO-PCT-4214-15601) claiming priority to U.S. Provisional Application No. 61/168,453 filed on Apr. 10, 2009, entitled “Method and System for the Exposure of Simplified Data-Service Facades Through a Context Aware Access-Layer” (Atty. Docket No. 34902-US-PRV-4214-15600), which these applications are incorporated by reference herein in their entirety.

### BACKGROUND

As used herein, the terms “client device,” “user agent,” “user device,” and “UA” might in some cases refer to mobile devices such as mobile telephones, personal digital assistants, handheld or laptop computers, and similar devices that have telecommunications capabilities. Such a UA might include a UA device and its associated removable memory module, such as but not limited to a Universal Integrated Circuit Card (UICC) that includes a Subscriber Identity Module (SIM) application, a Universal Subscriber Identity Module (USIM) application, or a Removable User Identity Module (R-UIM) application. Alternatively, such a UA might include the device itself without such a module. In other cases, the term “UA” might refer to devices that have similar capabilities but that are not transportable, such as desktop computers, set-top boxes, or network appliances. The term “UA” can also refer to any hardware or software component that can terminate a communication session for a user. Also, the terms “client device,” “user device,” “user agent,” “UA,” “user equipment,” “UA,” “user device” and “user node” might be used synonymously herein.

As telecommunications technology has evolved, more advanced network access equipment has been introduced that can provide services that were not possible previously. This network access equipment might include systems and devices that are improvements of the equivalent equipment in a traditional wireless telecommunications system.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a communications system according to an embodiment of the disclosure.

FIG. 2 is a block diagram of a communications system according to an embodiment of the disclosure.

FIG. 3 is a block diagram of a communications system according to an alternative embodiment of the disclosure.

FIG. 4 is a flow chart of a method for communicating according to an embodiment of the disclosure.

FIG. 5 illustrates a system that includes a processing component of a device, such as a user agent, suitable for implementing one or more embodiments disclosed herein.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Mobile communications devices, such as wireless phones and other user agents, often have limited bandwidth, meaning that data transmission rates between the mobile communication device and a server is limited relative to data transmission rates between devices connected by physical means. Thus, when a mobile communication system requests data, preferably as little data as possible should be sent. If possible, the data should be sent in a manner or in a format that is most suitable to the mobile communications device. Further, where practical, data interfaces should be provided that are simple and relatively straightforward for a mobile communications device to receive and process.

The embodiments provide for an intermediary between a client device and a data store that contains information of use to the client device. The intermediary may serve as one or more of a filter, a data processor, and a cache. Thus, when the client device makes a request for data, such as a user profile or a communication address within a user profile, the intermediary receives the request instead of the data store. The intermediary processes and/or formats the request using semantics particular to the data store. In response, the data store transmits the requested information to the intermediary. The intermediary may be characterized as a system, mechanism, device, or other tool.

In an embodiment, the intermediary is a context-aware device (software, hardware, or both) capable of processing the requested information in such a manner as to identify information that is relevant to the particular client device. Furthermore, the intermediary can format or expose a view of the information in a manner that is specific to the requesting client device. The intermediary device can then transmit the required information to the client device.

The intermediary device can also cache the relevant information. Thus, on subsequent requests by the client device, the intermediary can respond with the desired information quickly and efficiently. In the case that the requested information is part of an XML document, the intermediary can use an operator or pointer, such as “˜˜”, to immediately go to a specific sub-section of an XML document when retrieving information. For example, user Bob accesses his buddies through the intermediary located in an OMA (Open Mobile Alliance) XML (eXtensible Markup Language) XDMS (Document Management Server) referred to by the following URL: ‘http://www.abc.com/org.openmobilealliance.user-profile/users/bob@abc.com/user-profile’. The intermediary provides a ‘˜˜’ operator or pointer to Bob's client device, which represents the root of the user-profile document. At a later time, Bob's client device, providing Bob a view of a contact address, refers to his friend (Alice) user profile element as follows: ‘˜˜/user-profiles/user-profile[@uri=“sip:alice@example.com”]’.

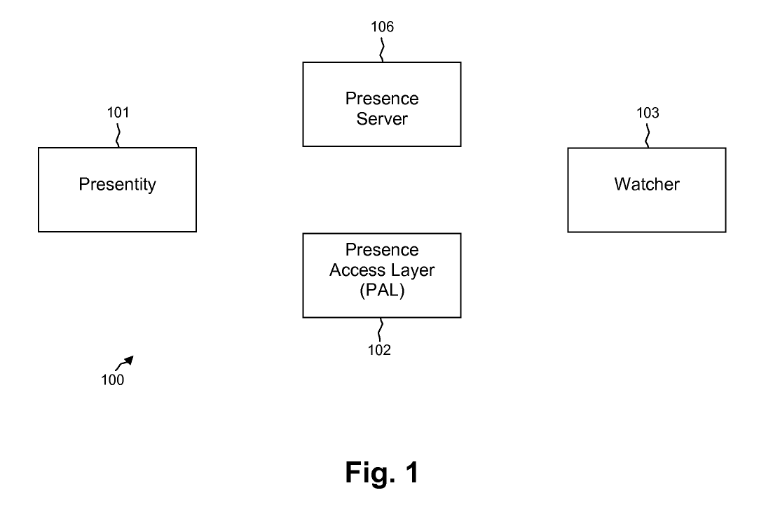

FIG. 1 is a block diagram of an embodiment of a system 100 that includes one or more presentities 101, one or more watchers 103, and a presence server 106. In some cases, a presence access layer (PAL) 102, as described below, might also be present. The PAL 102 might reside wholly or partially in the presence server 106, in the presentity 101, in the watcher 103, in one or more services or applications, and/or in one or more other network components. The functionality provided by the PAL 102 may be divided between these and/or other components. Alternatively, the PAL 102 might be a standalone component.

As mentioned above, the presentity 101 might be a human or non-human entity with which presence information is associated. The presentity 101 might reside wholly or partially on a UA or wholly or partially in a network or on a network component. Although not shown, multiple presence sources that capture presence information on behalf of the presentity 101 might be present. Multiple presentities 101 might also be present, and a single presence source might be associated with multiple presentities 101 and/or a single presentity 101 might be associated with multiple presence sources. Hereinafter, the term “presentity” might refer only to one or more presentities 101 or might refer to one or more presentities 101 and one or more associated presence sources. That is, no distinction will be made between a presentity and a presence source, but it should be understood that in some cases these can be separate entities.

The watcher 103 might be one or more humans, applications, services, or other entities that monitor or wish to consume presence information associated with the presentity 101. When the watcher 103 is an application or a service, the application or service might be wholly or partially resident on a UA. Alternatively, the application or service might be wholly or partially resident on a network component. Hereinafter, the term “watcher” might refer to a human, an application, or a service interested in presence information, to a UA or network component on which such an application or service resides, or to any combination of these entities.

The presentity 101 might be able to define which watchers 103 can receive the presentity's presence information and which presence information the watchers 103 can receive. As an example, the presentity user “Bob” might specify that all of his work supervisors can receive all of his presence information. He might also specify that the watcher “Alice” can receive information about his current willingness to communicate but can receive none of his other presence information, such as his current location. Alternatively or in combination with the above, another entity, such as Bob's employer, might designate which elements of Bob's presence information will be made available to which watchers 103. This embodiment may also apply to a service provider, or a principal administrator of a presence platform, where the service provider or the principal administrator specifies what elements can be shared.

A plurality of applications or services, such as instant messaging services or push-to-talk services, might be associated with the presentity 101, and these applications or services might be provided by one or more devices. The presentity 101 might publish presence information from a plurality of these devices. For example, Bob might be using a desktop computer and a handheld telephone simultaneously and may be considered available on either device. If Bob did not use the computer for an extended period of time, the computer might enter a sleep mode, and Bob might become unavailable on that device. However, he might remain available on the handset.

The presentity 101 can publish its presence information to the presence server 106. Only certain portions of the presence information might be made available to the watchers 103, and only certain watchers 103 might have access to the presence information. The presentity 101 or a third party (for example, a service provider or administrator) might publish rules or policies to the presence server 106 that define the portions of the presence information that will be made available to the watchers 103 and which of the portions will be made available to which of the watchers 103. The rules or polices might be established for groups of presentities 101 and/or groups of watchers 103. The rules or polices might be provided to the presence server 106 in a policy document. Alternatively, the presence information that will be made available to a particular watcher 103 might be determined at the time that watcher 103 requests presence information, possibly in combination with other factors. For example, a policy (e.g. a policy based on the domain name of the requesting watcher) may be used to further narrow the presence information distributed at request time.

As used herein, the term “rule” refers to a sequence of logic that, when executed, can specify actions. The term “policy” refers to parametric logic that can aid in the evaluation of a rule by, for example, providing hints or guidance, clarifying indeterminate or inconclusive scenarios during processing, or providing parameters. A distinction might also be made between a rule and a base rule and between a policy and a base policy. A base rule is typically a common interoperable rule or a default rule. For example, rule::findRelevantServiceTuple( ). That is, a base rule is a rule that is specified when no specific service or platform has overridden or changed it. Therefore, the term “rule” could refer to any rule, base or otherwise. Similarly, the term “policy” could refer to the set of all policies, and the term “base policy” could refer to a common or default policy that is used when a policy has not been overridden, extended, or enhanced.

The presence server 106 is a network component that receives presence information from the presentity 101 and provides presence information to the watcher 103. The rules or policies that define the presence information that will be made available to the watchers 103 might be stored on and/or processed by the presence server 106. When the watcher 103 wishes to receive presence information associated with the presentity 101, the watcher 103 can send a request to the presence server 106. The presence server 106 can then determine if the watcher 103 is authorized to receive the presentity's presence information. If the watcher 103 is authorized, the presence server 106 sends the presence information to the watcher 103.

Upon receiving the presence document, the watcher 103 parses the XML or other encoding scheme to extract the desired presence information. The entire presence document is typically parsed, regardless of the amount of presence information that is sought. For example, if the watcher 103 wished to learn the presentity's current willingness to communicate, the watcher 103 might need to sift through large amounts of unrelated data, such as the presentity's location, the presentity's willingness to use a particular service, the applications currently executing on the presentity's UA, and other information, to find the single data element that is desired.

In some cases, the watcher 103 might wish to learn a combination of information about the presentity 101. For example, if the watcher 103 wanted to send an instant message to the presentity 101, the watcher 103 might first attempt to determine the presentity's willingness to communicate and whether an instant messaging application is currently executing on the presentity's UA. In such cases, the watcher 103 might again send a single request for presence information to the presence server 106 and might again receive the entire presence document. The watcher 103 would then parse the entire document to find the plurality of data elements that are desired and perform the appropriate logical operations to correlate the data elements and derive the combination of information that was desired.

It may be possible that the presentity 101 did not specify whether or not the watcher 103 could have access to a data element that the watcher 103 is trying to obtain. It may also be possible that the presentity did not publish the data element, in which case the data element is missing or may not be available. In that case, the presence document may not contain the information that the watcher 103 is seeking. In such a case, the results of the watcher's parsing of the presence document may be indeterminate or inconclusive and the further actions the watcher 103 should take may not be clear.

In some cases, the system 100 may be configured with PAL 102 such that more efficient processing and dissemination of presence information is provided. The PAL 102 can abstract and simplify complex presence information on behalf of the watcher 103. That is, the PAL 102 can act as a proxy for the watcher 103 by: receiving a presence information request from the watcher 103; sending the request to the presence server 106; receiving a presence document from the presence server 106; parsing the information in the presence document; and returning to the watcher 103 a single value, such as “true” or “false”, as a response to the presence information request.

The PAL 102 allows the watcher 103 to submit a request for a single element of presence information, which can be referred to as a presence aspect. In addition, the presence aspect or aspects may represent simple presence information elements, such as availability, or more complex indications based on the correlated or logical abstractions, as described above. For example, the presentity's willingness to communicate might be a presence aspect, the presentity's current location might be another, the presentity's preferred means of communication might be another, and so on. The presence aspects are reusable, interoperable abstractions that can be applicable across a plurality of applications or services. The watcher 103 can send a message to the PAL 102 specifying a single presence aspect for which the watcher 103 is seeking information. The PAL 102 can then respond with information related only to that presence aspect such that the watcher 103 need not parse process or otherwise deal with a presence document.

As an example, if the watcher 103 wishes to learn whether the presentity 101 is currently willing to communicate, the watcher 103 can submit a request to the PAL 102 for information specifically about presence aspect willingness. If the presentity 101 has specified that the watcher 103 can have access to the presentity's willingness information, the PAL 102 can respond with a single value indicating the presentity's willingness or unwillingness to communicate (e.g. willingness is ‘true’ or unwillingness is ‘false’). The watcher 103 then needs to process only this single value. This can be contrasted with the situation where the PAL 102 is not present. In that case, the watcher 103 would ask for presence information in general, receive the entire presence document, and parse the presence document to determine the willingness aspect.

The PAL 102 can also process more complex requests from the watcher 103. For example, if the watcher 103 wished to determine a combination of information associated with the presentity 101, the watcher 103 might send the PAL 102 a request for each desired presence aspect. The PAL 102 might then return a response for each of the requests. Alternatively, the PAL 102 might correlate multiple presence aspects and return a single value to the watcher 103 that represents the combination of information that the watcher 103 was seeking. The PAL 102 might also process multiple presence aspects, and return several (bundled) values incorporated within an individual response to the watcher 103, representing the information that the watcher 103 was seeking. For example, the watcher may make separate requests, but the PAL 102 can bundle the responses when returning a response to the watcher. In a particular embodiment, a watcher asks separately for “willingness,” “contactable,” and “who-is-nearby.” A single response from PAL 102 could provide each of these aspects (i.e., as independent values) back to the watcher all bundled into a single message or response.

In addition to greatly simplifying the manner in which the watcher 103 requests, receives, and processes presence information, use of the PAL 102 allows processing that might previously have been performed by the watcher 103 to be offloaded to the PAL 102. In the cases where the PAL 102 is a standalone component or resides wholly or partially in the presence server 106 or some other network component, offloading the processing of presence information to the PAL 102 can free some of the processing capabilities of the watcher 103 for other purposes. An example of ‘other purposes’ could be fulfilling core functions of a presence aware application, such as media sharing in an instant messaging application. Further the reduction in message volume, message size, and processing overhead, which a result from operation of PAL 102, has benefits to a watcher 103 located on a mobile wireless device. Reduced message volume and size leaves more available bandwidth for a service provider to offer other services (e.g. instant-messaging, push-to-talk), while a reduction in processing preserves battery life on the mobile wireless device.

The PAL 102 may also process presence information on behalf of multiple applications or services that might otherwise redundantly perform the same presence information processing. That is, multiple applications or services might reside on or be available to the watcher 103, and each might have the capability to request, receive, and process presence information. Many of the steps that the applications or services take with regard to the presence information might be common to several of the applications or services. For example, there may be common presence-related rules or logic that would apply to both an instant messaging service and a push-to-talk service. If the PAL 102 is not present, each of these services might perform the common steps separately. If the PAL 102 is present, the PAL 102 can perform the common steps on behalf of each of these services and then return the results of the processing to the services. This can allow common procedures to occur only one time, thus increasing the efficiency of the watcher 103 and the applications or services it uses.

The PAL 102 can also ensure that indeterminate results are not returned to the watcher 103. As mentioned previously, if the watcher 103 seeks information about a presence aspect for which the presentity 101 has not provided information, the watcher's parsing of the presence document to determine that information might be inconclusive. The PAL 102, however, can contain functionality that specifies a definitive response to a presence information request even when information about the requested presence aspect is not available. For example, if the presentity 101 has not specified a willingness or an unwillingness to communicate, and if the watcher 103 submits a request for the presentity's willingness presence aspect, the PAL 102 might provide a default willingness value to the watcher 103. This default value may be associated as part of a rule and may also incorporate a policy type/value. Further, the value of the policy may be set based on the service, or may be changed or overridden by a PAL administrator, a service provider, or some other authorized user principal. In an example, the PAL 102 might indicate that the presentity 101 is unwilling to communicate for an indefinite period of time. In this way, the watcher 103 can be assured of receiving a usable and contextually meaningful response to any presence information request.

While the above discussion has focused on the PAL 102 providing presence information to the watcher 103 in response to the watcher's request for the current status of that information, the PAL 102 might also provide presence information based on a trigger defined by the watcher 103. That is, the watcher 103 might specify that it wishes to be informed when a change occurs in a presence aspect. When the PAL 102 detects that the specified change has occurred based on established rules and/or context (such as presence context), the PAL 102 can notify the watcher 103 of the change. A trigger might apply to a presence aspect alone or to a presence aspect in combination with one or more applications or services. Applicable triggers may be based on context. In addition, a trigger might be used to receive presence information from a plurality of presentities 101 and/or to provide presence information to a plurality of watchers 103.

As an example, the watcher 103 might have previously determined that the presentity's willingness presence aspect has a value that indicates that the presentity 101 is currently unwilling to communicate. The watcher 103 might wish to know if the presentity 101 becomes willing to communicate at a later point in time. The watcher 103 could either directly or indirectly, establish a trigger on the PAL 102 requesting to be notified of a change in the presentity's willingness presence aspect. The PAL 102 would then monitor the presentity's willingness presence aspect and would inform the watcher 103 if that presence aspect changed from “unwilling” to “willing”.

The use of the PAL 102 does not necessarily preclude the presence server 106 sending the presence document to the watcher 103. For example, if the watcher 103 wishes to obtain a large amount of presence information, there may be circumstances in which it is more efficient for the watcher 103 to parse the entire presence document received from the presence server 106 rather than processing multiple individual presence aspect values received from the PAL 102. The PAL 102 provides an upgrade option that might be used to hide complexity from the watcher 103 in some, possibly most or even all, circumstances.

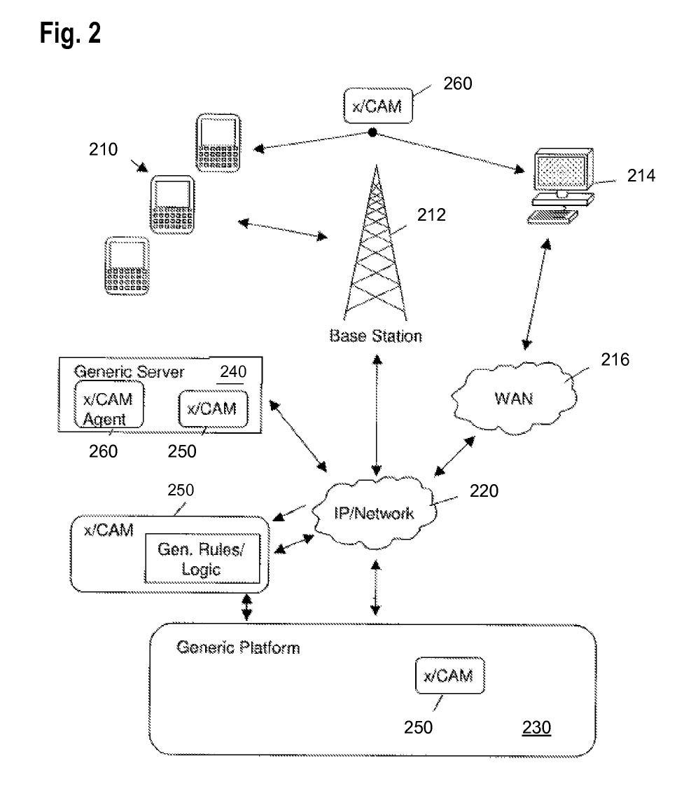

The above discussion was intended to provide sufficient information to promote an understanding of presence information in general and the presence access layer in particular. While the PAL may be employed in various systems (e.g., system 100 shown in FIG. 1) that use presence information, this disclosure does not require a PAL. Other, more generic or more specific systems may work with presence information, for example, as shown in FIG. 2.

FIG. 2 is a block diagram showing an example system in which a context aware mechanism has been added according to an embodiment of the disclosure. The embodiment shown in FIG. 2 can represent an exemplary implementation of system 100 of FIG. 1. A PAL 102, or p/CAM, is a presence-related x/CAM, with the term x/CAM referring to a more generic context aware mechanism. The x/CAM 250 shown in FIG. 2 may be configured on one or more system elements, possibly distributed as shown in FIG. 2. Additionally, one or more x/CAM agents 260 may be configured on one or more system elements. An x/CAM agent 260 may be self contained software or hardware on a server or a user agent, as opposed to being distributed among multiple systems. x/CAM 250 and x/CAM agents 260 are described further below.

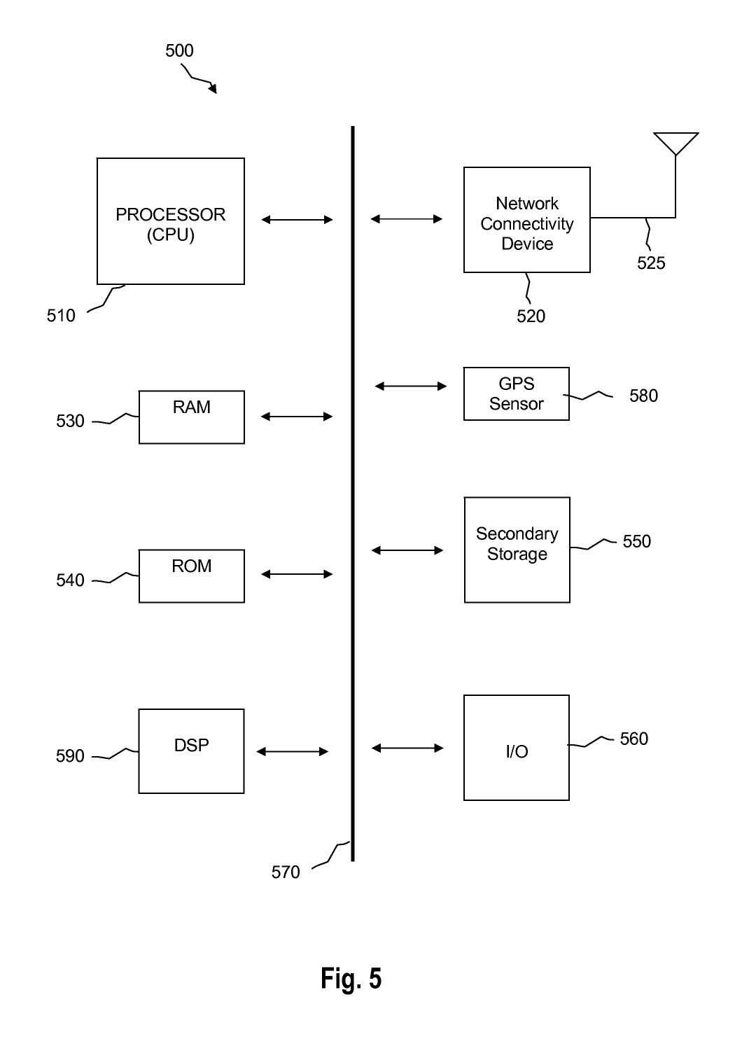

Applications possess functional utilities that have important characteristics known as context. Context is defined as “the set of information which surrounds, and gives meaning to something else.” Examples of context can be found, for example, in presence applications, location applications, among others. Context can be quantitatively represented by data stored as one or more files or databases on one or more computer readable medium, such as but not limited to RAM 530, ROM 540, Secondary Storage 550 of FIG. 5, or on a tangible storage medium.

With regard to presence information, presence metadata provides meaning and the presence information is the basis of the context. The meaning is applied to or part of a particular function or a particular feature of a function within an application to establish an appropriate set of processing steps.

Presence context determines what presence information is relevant. For example, if a presence context is for an instant messaging service, that context may establish that only “willingness” and “availability” are significant. In contrast, a presence context for a VoIP (voice over Internet call control) may establish that “willingness” and “contactable” are relevant. Presence context is based on factors such as, but not limited to service identification, identity of the watcher, a group to which the watcher belongs, and others. The resolution for the presence context is what establishes meaning in terms of how presence information is processed.

In one example, an instant message (IM) client application operable on a first user's mobile device may require functionality to establish whether other individuals or peers are reachable to permit the first user to initiate an IM chat session. It is also possible that within an IM client, functionalities are required to establish a peer user status icon to represent a second user. In the first scenario, context relates to whether the second user is reachable to initiate a chat. In the second scenario, the first user's IM client discriminates and derives a status icon based on the second user's status and availability to display the correct status icon, indicia or avatar. In the context of the IM client, reachability as it relates to a peer status icon feature may not be relevant, whereas reachability is helpful for facilitating the initiated chat function.

The above demonstrates, in a presence environment, that context plays a significant role in computing an individual's presence information to derive presence related aspects, including reachability, availability, among others. As will be appreciated, context also applies in other scenarios besides presence. For example, for a location, a relevant aspect may be based on an underlying “presence aspect” which relates to “who is nearby.” This aspect would allow a user on a device to establish whether one of his or her friends is in close physical proximity.

A presence service (such as but not limited to presence server 106 and presence access layer (PAL) 102 of FIG. 1) captures presence information from one or more presence sources (such as but not limited to presentity 101 of FIG. 1). Once this data is collected, a presence service composes or transforms the captured metadata and distributes a raw presence metadata document to authorized watchers (such as but not limited to watcher 103 of FIG. 1). An OMA-Presence service platform is a demonstrative example of a presence service. The OMA-Presence enabler outlines, in detail, semantics and policy related to the publication and consumption of presence information.

Returning to FIG. 2, user devices 210 communicate through a base station 212 with a network 220. Further, a desktop 214 (e.g., a computing device that is similar or different than user devices 210) communicates through a wide area network 216 with network 220. Also, a generic platform 230 is adapted to store data and states for various devices. Other servers such as a generic server 240 can exist within the network and can communicate over network 220.

The x/CAM 250 may be configured on one or more system elements, distributed as shown in FIG. 2 and as further described below. The x/CAM 250 is adapted to communicate with network 220 and with generic platform 230. In other embodiments, the x/CAM can be located on server 240. In yet further embodiments, the x/CAM can have x/CAM agents 260 that are located on user devices 210 or on server 240, respectively. In still further embodiments, the X/CAM can be part of the generic platform 230. Thus, an x/CAM may be in the generic platform 230, which might be a horizontal platform such as ‘presence’ (p/CAM) or ‘location’ (I/CAM) or some other more generic platform. Either generic platform 230 or a generic server, such as server 240, could be an OMA XDMS. Additionally, an x/CAM located on devices (such as x/CAM agent 260) can be a completely self-contained x/CAM. Still further, an x/CAM agent located on one or more devices could work in concert with any of the x/CAMs shown. Further still, an x/CAM agent 260 located in a server, such as an instant messaging server or server 240, could be provided without x/CAM 250. Additionally, a combination of x/CAM agents and/or x/CAMs could be located in one or more servers (such as a self contained push-to-talk server), such as in generic server 240. Because a given XDMS may be deployed or logically represented as separate entities, a combination of x/CAMs may be provided for each XDMS working together. For example, an x/CAM may be provided for a SharedProfile XDMS and another x/CAM may be provided for a SharedPolicy XDMS.

Thus, FIG. 2 illustrates abstracting a platform, whether it be presence, location, generic or a combination of the previous, to a context aware layer using context aware mechanisms or layers to support a multiplicity of application types or enablers. These techniques may be implemented utilizing policies and rules/triggers.

In accordance with one embodiment, a context or mechanism, whether it is presence, location or generic, may include one or more of policies, aspects, rules and triggers. A policy is associated with a particular presence context at an appropriate point in the application life cycle, to specify the behavior or treatment of presence, location or generic related aspects. Policies augment rules/logic flows by the manner in which they operate, to provide a more accurate and meaningful computation of aspects on behalf of a client application or enabler. As will be appreciated, a policy can apply to a class of applications, an individual application or even to a user and can be provisioned with settings regarding a manner in which aspects are computed.

Policy may be expressed using the Open Mobile Alliance (OMA) policy evaluation, enforcement and management (PEEM)/policy expression language (PEL). PEL defines a generic and extensible grammar in which policies may be expressed using a rule set language. PEL is based on Internet Engineering Task Force (IETF) request for comments (rfc) 4745. Conditions and/or actions (as specified in rfc 4745) may be enhanced within the scope of PEEM, through the OMA XDM (XML Document Management) common policy extensions, as detailed in OMA_SUP_XSD_XSD_xdm_extensions_V1_{—}0. The policy can also be expressed as in IETF rfc 4745. As will be appreciated, PEEM is a continuing standards effort by the OMA to define common functions needed by its enablers.

A relevant presence policy, for use by a presence context in the computation of presence aspects, could be an “opt-in-source” policy. This policy may indicate which presence element is an indicator of service opt-in. Two possible values could be “willing” and “ignore.” In an embodiment, the default value is “ignore,” which indicates that opt-in is not relevant for the given communication service. This exemplary policy, or some other policy, may have applicability to an OMA presence platform. The opt-in-source policy is meant as an example only; other policies are possible based on the needs of a system or user.

By extending common policy actions, x/CAM policies may be incorporated into a common policy PEL ‘ruleset’ XML document. A ‘ruleset’ may apply at a user scope or a global scope. For example, the ‘ruleset’ may apply to a class of service or a specific application. The ruleset may also apply to an individual user or group of users.

x/CAM related policies are referenced, resolved, and/or evaluated through the various PEEM requestor interfaces by the x/CAM server itself or a x/CAM enabled client/agent. That is, application or authentication protocols may provide specific metadata such as the requestor identity to the PEEM requestor interface, along with other metadata available to the PEEM servers as the basis for applying rules.

An example of a common policy PEL rule set XML document includes a single rule ‘a101’. This rule associates with a service enabler such as a PoC alert and defines specific policy settings/values be applied as a result of a match for a target resource. In this case, the target resource is the service identifier itself. This example makes an intentional correlation between the value of the common policy extension ‘ext:service[@enabler]’ attribute and the OMA PoC alert service-id as defined by OMA presence.

x/CAMs 250 from FIG. 2, as well as a PAL (such as PAL 102 of FIG. 1), can be implemented as a computer program product stored on a computer readable medium and executed by one or more processors, such as processing modules or units that are configured in servers or other computers. These x/CAMs can also be implemented as pure hardware or a combination of hardware and software.

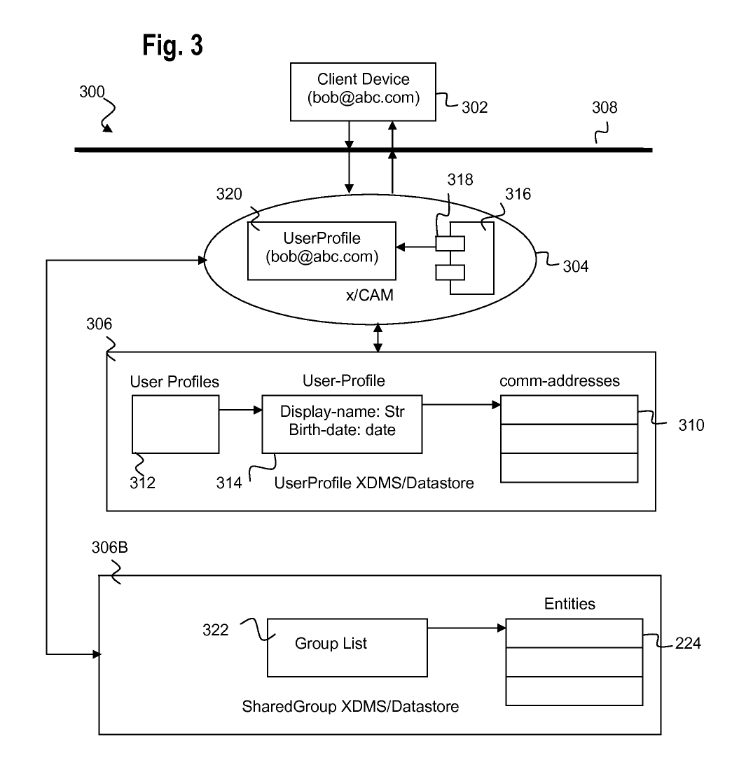

FIG. 3 is a block diagram of a communications system according to an alternative embodiment of the disclosure. Communication system 300 may use a context aware mechanism, such as an x/CAM 304, as an intermediary between client device 302 and network User Profile XDMS/Data store 306. The x/CAM 304 may or may not use a PAL 102. In other embodiments, User Profile XDMS/Data store 306 could be a combination of one or more other XDMS, data stores or databases. x/CAM 304 can be implemented as a computer program product stored on a computer readable medium, as hardware, or a combination of hardware and software. x/CAM 304 could be one or more of x/CAM 250 in FIG. 2, or could be another context aware mechanism, such as presence server 106. The intermediary (x/CAM 304 in one embodiment) may be characterized as a device, system, mechanism, or other tool, depending on how the intermediary is implemented. The embodiments describe an intermediary mechanism. However, the term “intermediary mechanism” should not be considered limited to a single device, or to a particular implementation, because the intermediary may be distributed among multiple devices, systems, mechanisms, or tools. The term “intermediary mechanism” refers to one or more, possibly distributed, hardware or software components that together perform the functions of the intermediary.

Broadly, the system embodiment 300 shown in FIG. 3 provides for an intermediary mechanism between a client device and a data store. The intermediary mechanism may be considered an interface, middle layer, front end, intermediary, façade, software, or other intermediary mechanism. Accordingly, these terms are used synonymously herein. In this embodiment, communication system 300 creates a system for retrieving and presenting contextually relevant information from User Profile XDMS/Data store 306 to client device 302.

The operation of x/CAM 304 may be described by way of an example. In an embodiment, user Bob, via client device 302, wishes to access profile information related to user Bob (i.e., himself). In previously known systems, client device 302 would directly send a request to User Profile XDMS/Data store 306 via network 308 to retrieve the information. The amount of information retrieved, however, could be large and/or presented in a manner that is not user friendly. Still further, each time client device 302 makes the request, even if such requests are repetitive, all of the information may be sent. Thus, client device 302 might consume excessive resources in order to process the requested profile information data and then present the desired data in a user-friendly format.

In a specific example, an entire XML data file might be retrieved in order to view a single users' email address stored within Bob's contacts using the XCAP protocol, an HTTP GET method would be transmitted via network 308 by client device 302 to User Profile XDMS/Data store 306 which would, assuming the client is authorized, return the user profile information in the form of an XML document or XML resource (i.e. an XML element or attribute). The resulting information would be large and difficult to process, and available bandwidth associated with network 308 may be partially or fully consumed by the volume and size of the information transmitted. Thus, to retrieve a single communication address 310, a set of user profiles 312 might be retrieved, which include the specific user profile 314. This process might be repeated each time client device 302 requested such information, even if the requests occurred closely in time.

Instead, an embodiment of the present disclosure provides the x/CAM 304 between the client device 302 and the data store. Preferably, a context aware mechanism, such as x/CAM 304, is used as the intermediary mechanism in order to present more relevant information to client device 302, and to transmit the information in a form such that client device 302 may easily present the information in a user-friendly format. The intermediary mechanism, x/CAM 304, may also be used to cache data previously retrieved by client device 302. In this manner, repetitive data may be presented to client device 302 in a more efficient manner, without having to re-retrieve information from UserProfile XDMS/Data store 306.

In an embodiment, when client device 302 requests communication address 310 via network 308, x/CAM 304 receives and processes the request. x/CAM 304 communicates with User Profile XDMS/Data store 306 to request the desired user profile information. The x/CAM 304 includes the functionality so that access to the set of user profiles 312 follows substantially all underlying data semantics. For example, as noted in OMA-TS-XDM_Shared_Profile-V1_{—}0-20080916-C, section 5.1.7, any access by client device 302 to UserProfile XDMS/Data store 306 through x/CAM 304 will ensure that <country> XML elements referred to are properly interpreted as ‘Alpha-2’ format and represented. Furthermore, attributes used to access the data, such as but not limited to communication address 310, would only see applicable addresses, which are the set of context-relevant addresses. In an embodiment, the set of context-relevant addresses are only those addresses that apply to client device 302 or are otherwise associated with user Bob and/or the applicable service currently in use.

The context-relevant user profile information 316, retrieved from the set of user profiles 312, is processed, and cached in x/CAM 304. Alternatively, pointers to individual users within the user profiles are created within the x/CAM 304 and cached for later use. In an embodiment, user profile information 316 includes particular user profiles 318, which include the cached profile 320 for client device 302 or user Bob.

Subsequent requests by client device 302 may reference the cached profile 320 (which is UserProfile(bob@abc.com)). Thus, when client device 302 makes a subsequent request for similar information, x/CAM 304 may provide contextually relevant information without having to make an additional request of User Profile XDMS/Data store 306. In an additional embodiment, the intermediary mechanism can include a pointer, operator, or other mechanism, such as “˜˜” in XDMS, to function like a database cursor into the cached profile 320 in x/CAM 304. As a result, the specific location of data within an XML document can be cached for purposes of further searches within an XML document, in addition to the location of the XML document itself.

The following provides still another example. In this exemplary embodiment, user Bob, via client device 302, wishes to access another friend's (Frank) user profile 312 in User Profile XDMS/Data store 306. A request is made by client device 302 via x/CAM 304 to a User Profile XDMS/Data store 306. The request is to retrieve Frank's user profile information, using the following reference ˜˜/user-profiles/user-profile[@uri=“sip:frank@foo.com”]’.

Because the x/CAM 304 may maintain a cached list of substantially all active user profiles, the x/CAM 304 is able to quickly respond to client device 302 with the relevant profile information. The x/CAM 304 may respond by providing a reference (again using a pointer “˜˜”), which refers or provides the specific location of Frank's profile information within an XML document identified by the URI described above. Alternatively, it may also provide the entire or relevant portions of Frank's profile information as is contextually required.

Access through a pointer or operator, such as “˜˜”, operates substantially similarly as if the entire UserProfile data entity resided within the x/CAM 304. For example, client device 302 may make a request to view Frank's communication addresses, by providing the following reference relative to Frank's profile ‘˜˜/communication-addresses’. The x/CAM 304 will, based on underlying OMA UserProfile XDM semantics, retrieve and provide these communication addresses in a contextually relevant and efficient format. The x/CAM 304 may use context data to determine which of the communication addresses are relevant and should be returned and/or presented. For example, a narrow set of communication addresses 310 may be presented based on applicable context available in x/CAM 304. In this example, x/CAM 304 does not present addresses to client device 302 that are not applicable to that specific client device and/or to the service with which Bob is attempting to contact Frank.

Communication system 300 can be used to provide efficient and simplified interfaces that include fine-grained data or business entities on behalf of resource constrained client devices over limited bandwidth networks. Communication system 300 makes contextually relevant information available to a requestor. Communication system 300 also decreases tight coupling between requesting client applications and one or more databases. For example, depending on the interface provided, it is possible to hide underlying changes or additions to the XMLSchema associated with the UserProfile XDM Application Usage on behalf of client device 302.

In some embodiments, the x/CAM 304 may combine aspects of representational state transfer (REST) with data transfer objects, and session-bean like business logic, in order to provide relevant information/behavior through a context-aware mechanism/layer on behalf of clients within a wireless infrastructure.

In a specific embodiment, the OMA XML Document Management “UserProfile” Application Usage, provided as part of the OMA XDM 2.0 enabler and referenced through OMA ServUserProf, includes fine-grained data entities represented by XMLSchema with relationships to other sub-data entities. A context-aware mechanism, such as an x/CAM 304, will have UserProfile extensible markup language document management server (XDMS) rules and semantics encoded within the context-aware mechanism.

As described above, the embodiments are not limited to x/CAM 304, and x/CAM 304 could be given different or additional functionalities. For example, in an embodiment, x/CAM 304 can be deployed or configured to operate as an OMA ServUserProf functional entity. In another example, OMA Group and List XDMS can be part of an XDM Enabler. In another embodiment, x/CAM 304 could provide functionalities associated with the OMA Presence Access Layer (PAL) v1.0 enabler. For example, as part of PAL, an x/CAM 304 may provide a data service façade for PAL profiles on behalf of a Service Provider and/or PAL administrator.

Other data stores and XDM application usages, and possibly other systems, could serve as an intermediary; thus, x/CAM 304 could be replaced or supplemented with such other databases, XDM application usages, or other systems. Other databases and systems could contain or cache profiles for applications different than XDMS. The x/CAM 304 may provide accessibility to these various systems and data stores to obtain client device information such as in the manner described above.

In a further embodiment, accessibility to different XDMS and/or data stores may be combined through an x/CAM 304. For example, a UserProfile XDM Application Usage and a Policy XDM Application Usage may be combined via one composite entity or interface for access by a client device 302. Thus, a single x/CAM could act as an intermediary mechanism for several XDMS types, such as but not limited to User Profile XDMS/Datastore 306, a policy XDMS, and an OMA CAB (Converged Address Book) XDMS. The use of a single x/CAM as an intermediary mechanism for multiple XDMS is described further below.

SharedGroup XDMS/datastore 306B may be a repository for group documents, such as buddy lists, that contain a list of people or entities that have some relationship or commonality with a client (Bob), such as the entities being on a common “push to talk” list. In other words, User Profile XDMS/Datastore 306 might contain groups of users that are available to communicate using the “push to talk” service. Group list 322 represents lists of groups, while entities 324 represent individual contacts within a given group.

Client device 302 might request information from multiple data stores, such as User Profile XDMS/Datastore 306 and SharedGroup XDMS/datastore 306B. Prior to the embodiments described herein, all of the information from both XDMS data stores would be received, consolidated, and processed at client device 302. This process could consume an undesirable amount of resources of client device 302.

However, in an embodiment, x/CAM 304 may receive and consolidate the information retrieved from User Profile XDMS/Datastore 306 and SharedGroup XDMS/datastore 306B to create a consolidated view of contextually relevant data. Thus, for example, user profile information 316 could be contextually relevant data representing people or entities retrieved from both User Profile XDMS/Datastore 306 and SharedGroup XDMS/datastore 306B, presented in a single composite view. x/CAM 304 may then transmit the single composite view, or alternatively sub-views or parts of the data, to client device 302. As a result, client device 302 may use comparatively few resources when receiving and processing the desired information.

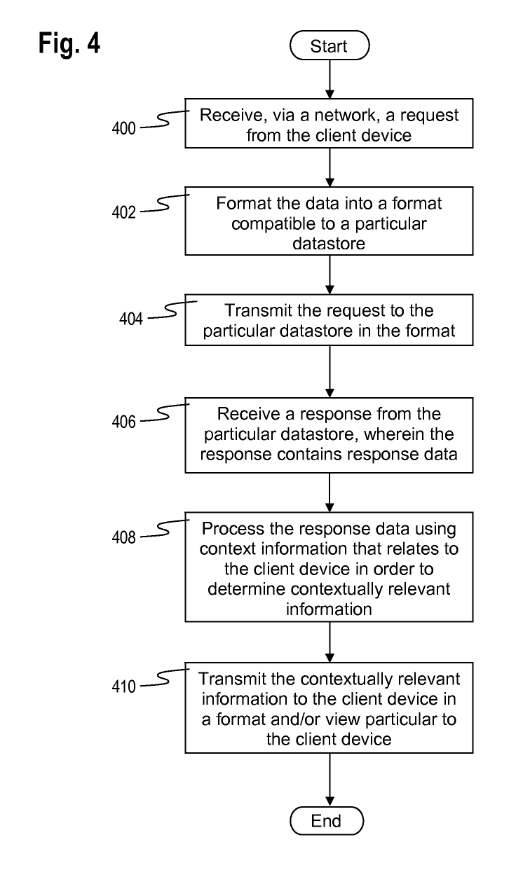

FIG. 4 is a flow chart of a method for communicating according to an embodiment of the disclosure. The process shown in FIG. 4 can be implemented using a context aware mechanism, such as x/CAM 304 in FIG. 3, implemented using hardware such as processors similar to those presented in FIG. 5 or those known in the art.

The process begins as the intermediary receives, via a network, a request from the client device (block 400). The intermediary formats the data into a format compatible to a particular data store (block 402). The intermediary then transmits the formatted request to the particular data store in the format (block 404).

Thereafter, the intermediary receives a response containing the request data from the particular data store (block 406). The intermediary processes the response data using context information that relates to the client device in order to determine and provide contextually relevant information and/or a contextually relevant view (block 408). Finally, the intermediary transmits the contextually relevant information in a representation or view based on context and possibly other criteria, to the client device (block 410). The process terminates thereafter.

The method described with respect to FIG. 4 may be extended. For example, the intermediary may cache the contextually relevant information at the intermediary and, upon receiving a subsequent request for the contextually relevant information from the client device, transmit the contextually relevant information from the cache to the client device.

In a specific embodiment, the contextually relevant information may be included in an XML document. In this case, the method may include retrieving information from a particular section of the XML document.

In another embodiment, the intermediary includes an x/CAM. In this case, the particular data store includes an extensible markup language document management system (XDMS) data store. Further, if the request relates to a user profile, and the response data includes a set of user profiles, the contextually relevant information may include user profile data relevant to the particular client device as specified by the applicable context. The user profile data may be principal data attributes used to access the requested data, such as but not limited to a communication address.

In an embodiment, the contextually relevant information is contained in less than all of response data. In another embodiment, the format and/or view follows semantics and/or rules particular to the data store. In this case, the intermediary may further transmit the contextually relevant information to the client device in a format that follows semantics and/or capabilities particular to the client device.

In still another embodiment, processing the response includes enabling a pointer based on the context information. In this case, the pointer points to user information stored on the particular data store. The pointer may further point to additional data stores. For example, information from multiple locations, such as a group list XDM and a UserProfile XDM, could be combined within an intermediary, so that the client device may be presented a composite data service façade based on the underlying data elements. The result is that the view provided to the client encompasses data elements, as part of the view, from the underlying elements (or correlated based on the underlying data in each XDM). Additionally, the user information may be a particular sub-portion of an XML document and the particular data store may be a user profile extensible markup language document management system (XDMS) data store.

In yet another embodiment, a context aware mechanism may receive information from multiple XDMS data stores, or other data stores, based on a request from a client device. The context aware mechanism then retrieves and consolidates the requested data according to rules, policies, and/or triggers in order to create a single consolidated view of the requested data. The consolidated view may represent only contextually relevant information. The consolidated view may then be transmitted to the client device. Thus, for example, a single request from the client device might result in requests for data from additional data stores. The response would then contain the additional response data from the additional data stores. The data from both the response data and the additional response data would be processed to determine the contextually relevant information. The contextually relevant information may then be presented in a composite view that represents at least some elements of both the response data and the additional response data.

The UA and other components described above might include a processing component that is capable of executing instructions related to the actions described above. FIG. 5 illustrates an example of a system 500 that includes a processing component 510 suitable for implementing one or more embodiments disclosed herein. In addition to the processor 510 (which may be referred to as a central processor unit or CPU), the system 500 might include network connectivity devices 520, random access memory (RAM) 530, read only memory (ROM) 540, secondary storage 550, and input/output (I/O) devices 560. These components might communicate with one another via a bus 570. In some cases, some of these components may not be present or may be combined in various combinations with one another or with other components not shown. These components might be located in a single physical entity or in more than one physical entity. Any actions described herein as being taken by the processor 510 might be taken by the processor 510 alone or by the processor 510 in conjunction with one or more components shown or not shown in the drawing, such as a digital signal processor (DSP) 590. Although the DSP 590 is shown as a separate component, the DSP 590 might be incorporated into the processor 510.

The processor 510 executes instructions, codes, computer programs, or scripts that it might access from the network connectivity devices 520, RAM 530, ROM 540, or secondary storage 550 (which might include various disk-based systems such as hard disk, floppy disk, SIM (subscriber identity module) card, or optical disk, or other storage device). While only one CPU 510 is shown, multiple processors may be present. Thus, while instructions may be discussed as being executed by a processor, the instructions may be executed simultaneously, serially, or otherwise by one or multiple processors. The processor 510 may be implemented as one or more CPU chips.

The network connectivity devices 520 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 520 may enable the processor 510 to communicate with the Internet or one or more telecommunications networks or other networks from which the processor 510 might receive information or to which the processor 510 might output information. The network connectivity devices 520 might also include one or more transceiver components 525 capable of transmitting and/or receiving data wirelessly. System 500 may be provided with a global satellite positioning system (GPS) sensor 580.

The RAM 530 might be used to store volatile data and perhaps to store instructions that are executed by the processor 510. The ROM 540 is a non-volatile memory device that typically has a smaller memory capacity than the memory capacity of the secondary storage 550. ROM 540 might be used to store instructions and perhaps data that are read during execution of the instructions. Access to both RAM 530 and ROM 540 is typically faster than to secondary storage 550. The secondary storage 550 is typically comprised of one or more disk drives or tape drives and might be used for non-volatile storage of data or as an over-flow data storage device if RAM 530 is not large enough to hold all working data. Secondary storage 550 may be used to store programs that are loaded into RAM 530 when such programs are selected for execution.

The I/O devices 560 may include liquid crystal displays (LCDs), touch screen displays, keyboards, keypads, switches, dials, mice, track balls, voice recognizers, card readers, paper tape readers, printers, video monitors, or other well-known input devices. Also, the transceiver 525 might be considered to be a component of the I/O devices 560 instead of or in addition to being a component of the network connectivity devices 520.

The embodiments provide for an intermediary mechanism. The intermediary mechanism is configured to receive a request from a client device, request the data from a data store, receive a response containing response data from the data store, process the response data using context information that relates to the client device to determine contextually relevant information, and transmit the contextually relevant information to the client device.

The embodiments also provide for a computer implemented method of processing a request from a client device to a data store. A request for data is received from the client device. The request for data is formatted into a format compatible to a particular data store. The request is transmitted to the particular data store. A response is received from the particular data store, wherein the response contains response data. The response data is processed using context information that relates to the client device to determine contextually relevant information. The contextually relevant information is transmitted to the client device.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. An intermediary mechanism comprising:
one or more processors configured to receive a request from a client device, request data from a data store according to the request, receive a response containing response data from the data store, process the response data using context information that relates to the client device to determine contextually relevant information, and transmit the contextually relevant information to the client device.

2. The intermediary mechanism of claim 1 wherein the processor is further configured to store the contextually relevant information in a cache and, upon receiving a subsequent request for the contextually relevant information from the client device, transmit the contextually relevant information from the cache to the client device.

3. The intermediary mechanism of claim 2 wherein the contextually relevant information comprises an XML document and wherein the processor is further configured to retrieve information from a particular section of the XML document.

4. The intermediary mechanism of claim 1 wherein the contextually relevant information is transmitted to the client device in at least one of a particular format and a particular view determined by the intermediary mechanism.

5. The intermediary mechanism of claim 1 wherein the intermediary mechanism comprises an x/CAM and wherein the data store comprises an extensible markup language document management system (XDMS) data store.

6. The intermediary mechanism of claim 5 wherein the request relates to a user profile, wherein the response data comprises a set of user profiles, and wherein the contextually relevant information comprises user profile data relevant to the particular client device.

7. The intermediary mechanism of claim 6 wherein the user profile data comprises a principal accessing data attribute.

8. The intermediary mechanism of claim 7 wherein the principal accessing data attribute comprises a communication address.

9. The intermediary mechanism of claim 1 wherein the contextually relevant information comprises less than all of response data.

10. The intermediary mechanism of claim 1 wherein the processor is further configured to transmit the request to the data store in a format that follows semantics or rules particular to the data store.

11. The intermediary mechanism of claim 10 wherein the processor is further configured to transmit the contextually relevant information to the client device in a format that follows one of semantics, capabilities, and a combination thereof, that are particular to the client device.

12. The intermediary mechanism of claim 1 wherein processing the response comprises enabling a pointer based on the context information, wherein the pointer points to user information stored on the data store.

13. The intermediary mechanism of claim 12 wherein the pointer further points to an additional data store.

14. The intermediary mechanism of claim 13 wherein the request from the client device also requests data from the additional data store, wherein the response also contains additional response data from the additional data store, wherein the one or more processors are further configured to process both the response data and the additional response data to determine the contextually relevant information, and wherein the contextually relevant information is presented in a composite view that represents at least some elements of both the response data and the additional response data.

15. The intermediary mechanism of claim 12 wherein the user information comprises a particular sub-portion of an XML document and wherein the data store comprises a user profile extensible markup language document management system (XDMS) data store.

16. A computer implemented method of processing a request from a client device to a data store, wherein the method comprises:
receiving, at a processor, a request for data from the client device;
formatting, at the processor, the request for data into a format compatible to a data store;
the processor causing the request to be communicated to the data store;
receiving, at the processor, a response from the data store, wherein the response contains response data;
processing, at the processor, the response data using context information that relates to the client device to determine contextually relevant information; and
the processor causing the contextually relevant information to be communicated to the client device.

17. The method of claim 16 wherein the contextually relevant information comprises an XML document and wherein the method further comprises:
the processor retrieving information from a particular section of the XML document.

18. The method of claim 16 wherein the request relates to a user profile, wherein the response data comprises a set of user profiles, and wherein the contextually relevant information comprises user profile data relevant to the client device.

19. The method of claim 16 wherein the user profile data comprises a principal accessing data attribute.

20. The method of claim 16 wherein the contextually relevant information comprises less than all of response data.

21. The method of claim 16 wherein the request for data comprises a first request made to a first data store and a second request made to a second data store, wherein the first request is received at the first data store and the second request is received at the second data store in corresponding formats, wherein receiving the response comprises receiving a first response comprising first response data from the first data store and receiving a second response comprising second response data from the second data store, wherein processing further comprises processing both the first response data and the second response data, and wherein the contextually relevant information is presented in a composite view that represents at least some elements of both the first response data and the second response data.

22. A computer readable medium having recorded thereon instructions for executing the method of claim 16.
